(19) United States
(12) Patent Application Publication
(10) Pub. No.: US 2024/0274779 A1
(43) Pub. Date: Aug. 15, 2024

(54) SECONDARY BATTERY ELECTRODE AND METHOD FOR MANUFACTURING SECONDARY BATTERY ELECTRODE

(71) Applicant: MURATA MANUFACTURING CO., LTD., Kyoto (JP)

(72) Inventor: Yayoi KATSU, Kyoto (JP)

(21) Appl. No.: 18/643,426

(22) Filed: Apr. 23, 2024

Related U.S. Application Data
(63) Continuation of application No. PCT/JP2022/039156, filed on Oct. 20, 2022.

(30) Foreign Application Priority Data
Nov. 5, 2021 (JP) 2021-181333

(51) Int. Cl. H01M 4/04; H01M 4/02

(52) U.S. Cl. CPC H01M 4/0404; H01M 4/043; H01M 2004/021

(57) ABSTRACT

A secondary battery electrode is provided and including: a current collector; and an electrode material layer provided on the current collector, where the electrode material layer includes a first region, a second region, and a third region, the first region and the third region are provided on the current collector, the second region is provided at least on the first region, and the first region, the second region, and the third region are higher in porosity in this order.

### CROSS REFERENCE TO RELATED APPLICATIONS

The present application is a continuation of PCT patent application no. PCT/JP2022/039156, filed on Oct. 20, 2022, which claims priority to Japanese patent application no. 2021-181333, filed on Nov. 5, 2021, the entire contents of which are incorporate herein by reference.

### BACKGROUND

The present application relates to a secondary battery electrode, and a method for manufacturing the secondary battery electrode.

Conventionally, a secondary battery that can be repeatedly charged and discharged has been used for various applications. For example, secondary batteries are used as power supplies for electronic devices such as smart phones and notebook computers.

A secondary battery has a structure in which an electrode assembly including a positive electrode, a negative electrode, and a separator disposed between the electrodes of the positive electrode and the negative electrode, and an electrolyte are housed in an exterior body. The positive electrodes each includes a current collector, and an electrode material layer provided on at least one main surface of the current collector. Specifically, the positive electrode includes a positive electrode current collector, and a positive electrode material layer provided on at least one main surface of the positive electrode current collector. The negative electrode includes a negative electrode current collector, and a negative electrode material layer provided on at least one main surface of the negative electrode current collector.

### SUMMARY

The present application relates to a secondary battery electrode, and a method for manufacturing the secondary battery electrode.

In recent years, there has been a growing demand for the increased energy densities and power of secondary batteries. For meeting such a demand, some secondary batteries include a current collector and an electrode material layer that has a stacked structure in the stacking direction, from the viewpoints of improving the electron conductivity and improving the ion diffusivity in the electrode material layer, which is a constituent element of an electrode. As an example, the electrode material layer of the stacked structure can be composed of: a first region that is located on the proximal side with respect to the current collector and is relatively lower in porosity; and a second region that is located on the distal side with respect to the current collector and is relatively higher in porosity.

In this regard, the inventor of the present application has newly found that conventional secondary battery electrodes have matters that can be still improved in the following respects. Specifically, as mentioned above, if the electrode material layer employs the stacked structure composed of the first region that is lower in porosity and the second region that is higher in porosity, ions will remain diffused sequentially in the order from one main surface (separator) side of the electrode material layer to the other main surface (current collector) side thereof in the stacking (depth) direction in the electrode material layer on the side where ions enter at the time of charging and discharging the battery. Thus, it may still take a predetermined time for the ions to reach the inside of the first region that is lower in porosity, particularly to reach the interface region with the current collector. More specifically, when the electrode material layer employs the conventional stacked structure, it is difficult to say that an improvement in ion diffusivity is sufficiently achieved in addition to an improvement in electron conductivity.

The present technology has been devised in view of such circumstances. In an embodiment, the present application relates to providing a secondary battery electrode and a method for manufacturing an electrode for a secondary battery, which are capable of suitably achieving an improvement in electron conductivity and an improvement in ion diffusivity.

According to an embodiment, provided is a secondary battery electrode including:
a current collector; and
an electrode material layer provided on the current collector,
where the electrode material layer includes a first region, a second region, and a third region,
the first region and the third region are provided on the current collector,
the second region is provided at least on the first region, and
the first region, the second region, and the third region are higher in porosity in this order.

According to an embodiment, provided is a method for manufacturing a secondary battery electrode, including steps of:
(i) preparing a current collector;
(ii) providing an electrode material layer slurry on the current collector to form an electrode precursor; and
(iii) drying and pressing the electrode precursor,
where the step (ii) includes: intermittently applying at least two parts of a first electrode material layer slurry at a predetermined interval; and continuously applying, on the at least two parts of the first electrode material layer slurry, a second electrode material layer slurry that is relatively lower in the volume ratio of a solid content containing an active material than the first electrode material layer slurry.

The secondary battery electrode according to an embodiment is capable of suitably achieving an improvement in electron conductivity and an improvement in ion diffusivity.

### BRIEF DESCRIPTION OF THE FIGURES

FIG. 1A is a sectional view schematically illustrating a secondary battery including a secondary battery electrode according to an embodiment of the present application.

FIG. 1B is a sectional view schematically illustrating the secondary battery electrode according to an embodiment of the present application.

FIG. 2 is a sectional view schematically illustrating a difference in electrolytic solution permeability in an electrode material layer including regions that are different in porosity.

FIG. 3A is a sectional view schematically illustrating a method for manufacturing the secondary battery electrode according to an embodiment (a step of intermittently applying a first electrode material layer slurry).

FIG. 3B is a sectional view schematically illustrating the method for manufacturing the secondary battery electrode according to an embodiment (a step of continuously applying a second electrode material layer slurry).

FIG. 3C is a sectional view schematically illustrating a method for manufacturing the secondary battery electrode according to an embodiment of the present application (a step of forming an electrode material layer).

FIG. 3D is an enlarged sectional view schematically illustrating a step of forming the electrode material layer including a third region.

FIG. 4A is a sectional view schematically illustrating a secondary battery including a secondary battery electrode according to another embodiment of the present application.

FIG. 4B is a plan view schematically illustrating the secondary battery electrode according to another embodiment along a line segment I-I′ or a line segment II-II′ in FIG. 4A.

FIG. 4C is a sectional view schematically illustrating the secondary battery electrode according to another embodiment of the present application.

FIG. 4D is an enlarged sectional view schematically illustrating an electrode material layer that is a constituent element of the secondary battery electrode according to another embodiment of the present application.

FIG. 5A is a plan view schematically illustrating a possible form for a third region of an electrode material layer.

FIG. 5B is a plan view schematically illustrating a possible form for a third region of an electrode material layer.

FIG. 5C is a plan view schematically illustrating a possible form for a third region of an electrode material layer.

FIG. 6 is a sectional view schematically illustrating a basic configuration of an electrode constituting layer.

FIG. 7 is a graph showing a relationship between a linear pressure and a density on active materials.

### DETAILED DESCRIPTION

A secondary battery electrode according to an embodiment of the present application will be described below in further detail including with reference to the drawings. Various elements in the drawings are merely shown schematically and exemplarily for the understanding of the present application, and the appearance, dimensional ratios, and the like may be different from actual ones.

Before specifically describing a secondary battery electrode according to an embodiment, the basic configuration of the secondary battery will be described. It is to be noted that the term “secondary battery” as used in the present specification refers to a battery that can be repeatedly charged and discharged. The “secondary battery” is not to be considered unduly restricted by the name of the secondary battery, which can encompass, for example, a “power storage device” and the like. The term “plan view” as used in the present specification means an object as viewed from the upper side or lower side thereof in the thickness direction based on the direction of stacking electrode materials constituting the secondary battery. In addition, the term “sectional view” as used in the present specification refers to an object as viewed from a direction substantially perpendicular to the thickness direction based on the direction of stacking electrode materials constituting the secondary battery. The terms “vertical direction” and “horizontal direction” directly or indirectly used in the present specification respectively correspond to a vertical direction and a horizontal direction in the drawings. Unless otherwise specified, the same symbols or signs shall denote the same members or sites or the same meanings. According to a preferred aspect, it can be understood that a downward direction in a vertical direction (that is, a direction in which gravity acts) corresponds to a “downward direction”, whereas the opposite direction corresponds to an “upward direction”.

Various numerical ranges mentioned herein are intended to include the numerical values themselves of the lower and upper limits. More specifically, when a numerical range such as 1 to 10 is taken as an example, the example can be interpreted as including the lower limit of “1” and also including the upper limit of “10”.

The secondary battery has a structure in which an electrode assembly and an electrolyte are housed and enclosed inside an exterior body. The electrode assembly may include a positive electrode, a negative electrode, and a separator disposed between the positive electrode and the negative electrode. The electrode assembly may be a stacked electrode assembly or a wound (jelly roll type) electrode assembly. The stacked electrode assembly is obtained by stacking a plurality of electrode constituting layers each including a positive electrode, a negative electrode, and a separator. The wound electrode assembly is obtained by winding a plurality of electrode constituting layers each including a positive electrode, a negative electrode, and a separator. In addition, for example, the electrode assembly may have a so-called stack and folding structure obtained by stacking, on a long film, and then folding a positive electrode, a separator, and a negative electrode.

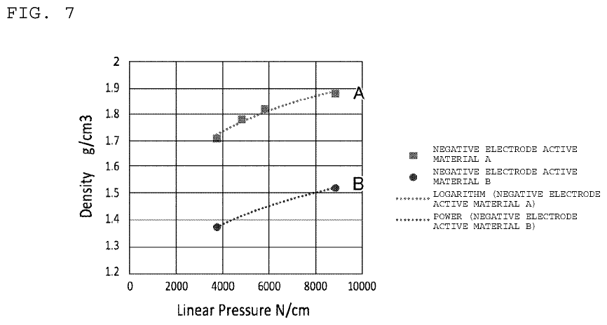

A positive electrode 10A includes at least a positive electrode current collector 11A and a positive electrode material layer 12A (see FIG. 6), and the positive electrode material layer 12A is provided on at least one surface of the positive electrode current collector 11A. At a site of the positive electrode current collector 11A without the positive electrode material layer 12A provided, that is, an end of the positive electrode current collector 11A, a positive electrode-side extended tab is positioned. The positive electrode material layer 12A contains therein a positive electrode active material as an electrode active material. A negative electrode 10B includes at least a negative electrode current collector 11B and a negative electrode material layer 12B (see FIG. 6), and the negative electrode material layer 12B is provided on at least one surface of the negative electrode current collector 11B. At a site of the negative electrode current collector 11B without the negative electrode material layer 12B provided, that is, an end of the negative electrode current collector 11B, a negative electrode-side extended tab is positioned. The negative electrode material layer 12B contains therein a negative electrode active material as an electrode active material.

The positive electrode active material included in the positive electrode material layer 12A and the negative electrode active material included in the negative electrode material layer 12B are substances directly involved in the transfer of electrons in the secondary battery and are main positive and negative electrode main substances responsible for charge-discharge, namely a battery reaction. More specifically, ions are brought into the electrolyte due to “the positive electrode active material included in positive electrode material layer 12A” and “the negative electrode active material included in negative electrode material layer 12B”, and such ions move between the positive electrode 10A and the negative electrode 10B to transfer electrons, thereby leading to charge-discharge. The positive electrode material layer 12A and the negative electrode material layer 12B are preferably layers capable of occluding and releasing, in particular, lithium ions. More specifically, a secondary battery is preferred in which lithium ions move between the positive electrode 10A and the negative electrode 10B through the electrolyte to charge and discharge the battery. When lithium ions are involved in charge-discharge, the secondary battery corresponds to a so-called “lithium ion battery”.

The positive electrode active material of the positive electrode material layer 12A is made of, for example, a granular material, and a binder is preferably included in the positive electrode material layer 12A for more sufficient contact between grains and shape retention. Furthermore, a conductive auxiliary agent may be included in the positive electrode material layer 12A to facilitate transfer of electrons that promotes the battery reaction. Similarly, the negative electrode active material of the negative electrode material layer 12B is made of, for example, a granular material, a binder is preferably included in the negative electrode material layer 12B for more sufficient contact between grains and shape retention, and a conductive auxiliary agent may be included in the negative electrode material layer 12B to facilitate transfer of electrons that promotes the battery reaction. The positive electrode material layer 12A and the negative electrode material layer 12B can be respectively referred to also as a “positive electrode mixture layer” and a “negative electrode mixture layer”, because multiple components are contained therein described above.

The positive electrode active material is preferably a material that contributes to occlusion and release of lithium ions. From such a viewpoint, the positive electrode active material is preferably, for example, a lithium-containing composite oxide. More specifically, the positive electrode active material is preferably a lithium transition metal composite oxide containing lithium and at least one transition metal selected from the group consisting of cobalt, nickel, manganese, and iron. In other words, such a lithium transition metal composite oxide is preferably included as a positive electrode active material in the positive electrode material layer 12A of the secondary battery. For example, the positive electrode active material may be a lithium cobaltate, a lithium nickelate, a lithium manganate, a lithium iron phosphate, or a material obtained by replacing a part of the transition metal thereof with another metal. Such positive electrode active materials may be included as a single species, or two or more species thereof may be included in combination. In a more preferred aspect, the positive electrode active material contained in the positive electrode material layer 12A is a lithium cobaltate.

The binder that can be included in the positive electrode material layer 12A is not particularly limited, and examples of the binder include at least one selected from the group consisting of a polyvinylidene fluoride, a vinylidene fluoride-hexafluoropropylene copolymer, a vinylidene fluoride-tetrafluoroethylene copolymer, a polytetrafluoroethylene, and the like. The conductive auxiliary agent that can be included in the positive electrode material layer 12A is not particularly limited, and examples thereof include at least one selected from carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, and polyphenylene derivatives. For example, the binder of the positive electrode material layer 12A may be a polyvinylidene fluoride. By way of example only, the conductive auxiliary agent of the positive electrode material layer 12A is carbon black. Furthermore, the binder and conductive auxiliary agent of the positive electrode material layer 12A may be a combination of polyvinylidene fluoride and carbon black.

The negative electrode active material is preferably a material that contributes to occlusion and release of lithium ions. From such a viewpoint, the negative electrode active material is preferably, for example, various carbon materials, oxides, lithium alloys, or the like.

Examples of the various carbon materials for the negative electrode active material include graphite (natural graphite and artificial graphite), soft carbon, hard carbon, and diamond-like carbon. In particular, graphite is preferred in terms of high electron conductivity and excellent adhesiveness to the negative electrode current collector 11B. Examples of the oxides for the negative electrode active material include at least one selected from the group consisting of a silicon oxide, a tin oxide, an indium oxide, a zinc oxide, and a lithium oxide. The lithium alloy for the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, or La. Such an oxide is preferably amorphous as its structural form. This is because deterioration due to nonuniformity such as crystal grain boundaries or defects is less likely to be caused. By way of example only, the negative electrode active material of the negative electrode material layer 12B may be artificial graphite.

The binder that can be included in the negative electrode material layer 12B is not particularly limited, and examples thereof include at least one selected from the group consisting of a styrene butadiene rubber, a polyacrylic acid, a polyvinylidene fluoride, a polyimide-based resin, and a polyamideimide-based resin. For example, the binder included in the negative electrode material layer 12B may be a styrene-butadiene rubber. The conductive auxiliary agent that can be included in the negative electrode material layer 12B is not particularly limited, and examples thereof include at least one selected from: carbon black such as thermal black, furnace black, channel black, ketjen black, and acetylene black; carbon fibers such as graphite, carbon nanotubes, and vapor grown carbon fibers; metal powders such as copper, nickel, aluminum, and silver; and polyphenylene derivatives. It is to be noted that the negative electrode material layer 12B may include therein a component derived from a thickener component (for example, a carboxymethyl cellulose) used at the time of manufacturing the battery.

By way of example only, the negative electrode active material and binder in the negative electrode material layer 12B may be a combination of artificial graphite and styrene-butadiene rubber.

The positive electrode current collector 11A and the negative electrode current collector 11B used for the positive electrode 10A and the negative electrode 10B are members that contribute to collecting and supplying electrons generated in the active materials due to the battery reaction. Such a current collector may be a metal member in a sheet form, and may have a porous or perforated form. For example, the current collector may be a metal foil, a punching metal, a net, an expanded metal, or the like. The positive electrode current collector 11A used for the positive electrode 10A is preferably made of a metal foil containing at least one selected from a group consisting of aluminum, stainless steel, nickel, and the like, and may be, for example, an aluminum foil. In contrast, the negative electrode current collector 11B used for the negative electrode 10B is preferably made of a metal foil containing at least one selected from the group consisting of copper, stainless steel, and nickel, and may be, for example, a copper foil.

A separator 50 is a member provided from the viewpoints such as preventing a short circuit due to contact between the positive and negative electrodes and of holding the electrolyte. In other words, the separator 50 can be considered as a member that allows ions to pass while preventing electronic contact between the positive electrode 10A and the negative electrode 10B. Preferably, the separator 50 is a porous or microporous insulating member and has a membrane form due to its small thickness. By way of example only, a microporous membrane made of a polyolefin may be used as the separator. In this respect, the microporous membrane for use as the separator 50 may contain, for example, only polyethylene (PE) or only polypropylene (PP) as the polyolefin. Furthermore, the separator 50 may be a laminate composed of a “microporous membrane made of PE” and a “microporous membrane made of PP”. The surface of the separator 50 may be covered with an inorganic particle coating layer and/or an adhesive layer or the like. The surface of the separator may have adhesiveness.

It is to be noted that the separator 50 should not be particularly restricted by its name, and may be a solid electrolyte, a gel-like electrolyte, insulating inorganic particles, and the like, which have a similar function. Further, from the viewpoint of further improving handling of the electrodes, the separator 50 and the electrode (positive electrode 10A/negative electrode 10B) are preferably bonded. The separator 50 can be bonded to the electrode by using an adhesive separator as the separator 50, by application and/or thermocompression bonding of an adhesive binder onto the electrode material layer (positive electrode material layer 12A/negative electrode material layer 12B), or the like. Examples of the material of the adhesive binder that provides adhesiveness to the separator 50 or the electrode material layer include a polyvinylidene fluoride, a vinylidene fluoride-hexafluoropropylene polymer, and an acrylic resin. The thickness of the adhesive layer by the adhesive binder application or the like may be 0.5 μm or more and 5 μm or less.

When the positive electrode 10A and the negative electrode 10B have a layer capable of occluding and releasing lithium ions, the electrolyte is preferably a “nonaqueous” electrolyte such as an organic electrolyte and/or an organic solvent (that is, the electrolyte is preferably a nonaqueous electrolyte). In the electrolyte, metal ions released from the electrode (positive electrode 10A/negative electrode 10B) will be present, and the electrolyte will thus assist the movement of the metal ions in the battery reaction.

The non-aqueous electrolyte is an electrolyte including a solvent and a solute. As a specific solvent for the nonaqueous electrolyte, a solvent containing at least a carbonate is preferred. Such a carbonate may be cyclic carbonates and/or chain carbonates. Although not particularly limited, examples of the cyclic carbonates include at least one selected from the group consisting of a propylene carbonate (PC), an ethylene carbonate (EC), a butylene carbonate (BC), and a vinylene carbonate (VC). Examples of the chain carbonates include at least one selected from the group consisting of a dimethyl carbonate (DMC), a diethyl carbonate (DEC), an ethyl methyl carbonate (EMC), and a dipropyl carbonate (DPC). By way of example only, combinations of the cyclic carbonates and the chain carbonates are used as a nonaqueous electrolyte, and for example, a mixture of ethylene carbonate and diethyl carbonate may be used. In addition, as a specific solute for the nonaqueous electrolyte, for example, an Li salt such as LiPF₆ or LiBF₄ is preferably used. In addition, as a specific solute for the nonaqueous electrolyte, for example, an Li salt such as LiPF₆ and/or LiBF₄ is preferably used.

As a positive electrode current collecting lead and a negative electrode current collecting lead, it is possible to use any current collector lead that is used in the field of secondary battery. Such a current collecting lead may be made of a material that can achieve the movement of electrons, and is made of, for example, a conductive material such as aluminum, nickel, iron, copper, and stainless steel. The positive electrode current collecting lead is preferably made of aluminum, and the negative electrode current collecting lead is preferably made of nickel. The forms of the positive electrode current collecting lead and negative electrode current collecting lead are not particularly limited, and may be, for example, a wire or plate shape.

Any external terminal that is used in the field of secondary battery can be used as an external terminal. Such an external terminal collecting lead may be made of a material that can achieve the movement of electrons, and is typically made of a conductive material such as aluminum, nickel, iron, copper, and stainless steel. The external terminal 5 may be electrically and directly connected to a substrate, or may be electrically and indirectly connected to the substrate with another device interposed therebetween. It is to be noted that the external terminal is not limited thereto, and a positive electrode current collecting lead that is connected to each of the plurality of positive electrodes may have the function of a positive electrode external terminal, whereas a negative electrode current collecting lead that is connected to each of the plurality of negative electrodes may have the function of a negative electrode external terminal.

The exterior body may have the form of a conductive hard case or a flexible case (such as a pouch). When the form of the exterior body is a flexible case (such as a pouch), each of the plurality of positive electrodes is connected to the positive electrode external terminal with the positive electrode current collecting lead interposed therebetween. The positive electrode external terminal is fixed to the exterior body with a sealing part, and the sealing part prevents the electrolyte from being leaked. Similarly, each of the plurality of negative electrodes is connected to the negative electrode external terminal with the negative electrode current collecting lead interposed therebetween. The negative electrode external terminal is fixed to the exterior body with a sealing part, and the sealing part prevents the electrolyte from being leaked. It is to be noted that the external terminal is not limited thereto, and a positive electrode current collecting lead that is connected to each of the plurality of positive electrodes may have the function of a positive electrode external terminal, whereas a negative electrode current collecting lead that is connected to each of the plurality of negative electrodes may have the function of a negative electrode external terminal. When the form of the exterior body is a conductive hard case, each of the plurality of positive electrodes is connected to the positive electrode external terminal with the positive electrode current collecting lead interposed therebetween. The positive electrode external terminal is fixed to the exterior body with a sealing part, and the sealing part prevents the electrolyte from being leaked.

The conductive hard case is composed of a main body and a lid. The main body is composed of a bottom constituting the bottom surface of the exterior body and a side surface part. The main body and the lid are subjected to sealing after housing the electrode assembly, the electrolyte, the current collecting leads, and the external terminals. The sealing method is not particularly limited, and examples thereof include a laser irradiation method. As a material constituting the main body and the lid, it is possible to use any material that can constitute a hard case type exterior body in the field of secondary battery. Such a material may be any material that can achieve the movement of electrodes, and examples of the material can include conductive materials such as aluminum, nickel, iron, copper, and stainless steel. The dimensions of the main body and lid are determined mainly depending on the dimensions of the electrode assembly, and the main body and the lid preferably have dimensions, for example, to the extent that the movement (displacement) of the electrode assembly within the exterior body is prevented when the electrode assembly is housed. Preventing the movement of the electrode assembly prevents the electrode assembly from being broken, and improves the safety of the secondary battery.

The flexible case is composed of a soft sheet. The soft sheet only needs to have such a degree of softness that can achieve bending of the sealing part, and is preferably a plastic sheet. The plastic sheet is a sheet that has the property of maintaining the deformation by an external force when the external force is applied and then removed, and for example, a so-called laminate film can be used. A flexible pouch formed from a laminate film can be manufactured, for example, by stacking two laminate films on one another and heat-sealing a peripheral edge thereof. As the laminate film, a film obtained by laminating a metal foil and a polymer film is common, and specifically, a three-layer film composed of an outer layer polymer film/a metal foil/an inner layer polymer film is exemplified. The outer layer polymer film is intended to prevent damage to the metal foil due to permeation and contact of moisture and the like, and polymers such as a polyamide and a polyester can be suitably used. The metal foil is intended to prevent permeation of moisture and gas, and a foil of copper, aluminum, stainless steel, or the like can be suitably used. The inner layer polymer film is intended to protect the metal foil from the electrolyte housed inside, and for melt-sealing at the time of heat sealing, and polyolefin or acid-modified polyolefin can be suitably used.

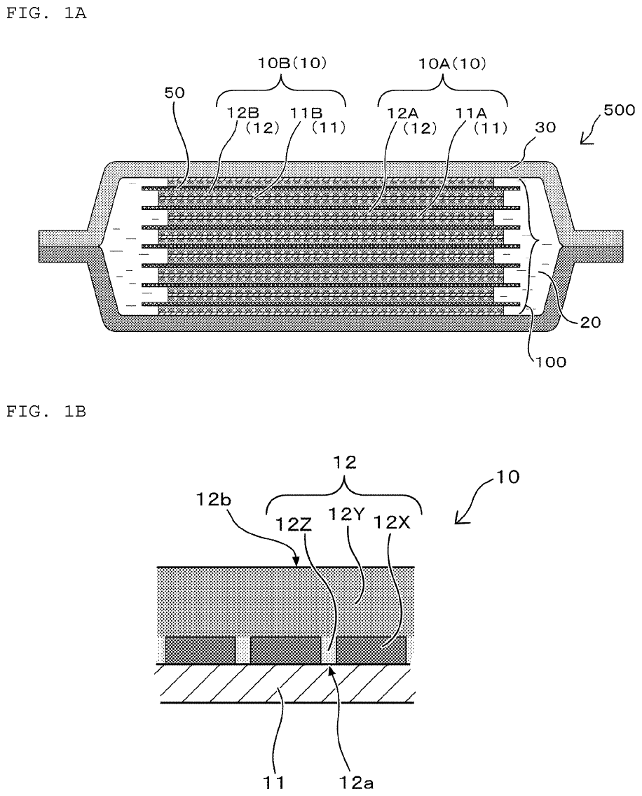

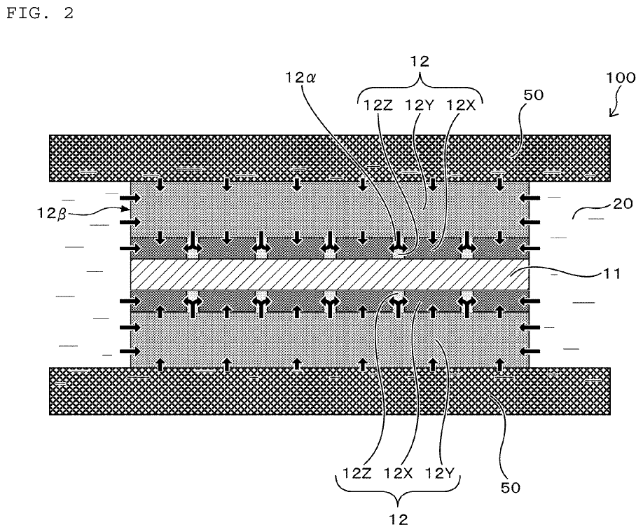

As described in the basic configuration of the secondary battery, the secondary battery 500 has a structure in which the electrode assembly 100 including the positive electrode 10A, the negative electrode 10B, and the separator 50 disposed between the electrodes 10 of the positive electrode 10A and the negative electrode 10B; and the electrolyte 20 are housed in the exterior body 30 (see FIG. 1A). The positive electrode 10A includes the positive electrode current collector 11A, and the positive electrode material layer 12A provided on at least one main surface of the positive electrode current collector 11A. The negative electrode 10B includes the negative electrode current collector 11B, and the negative electrode material layer 12B provided on at least one main surface of the negative electrode current collector 11B.

The present technology is characterized in the configuration of the secondary battery electrodes 10, which are constituent elements of the secondary battery 500 according to an embodiment. The inventor of the present application has earnestly studied the configurations of secondary battery electrodes capable of suitably improving electron conductivity and ion diffusivity. For example, the inventor of the present application has earnestly studied the configurations of secondary battery electrodes from the viewpoint of “how quickly ions are allowed to reach the inside of a predetermined region of an electrode material layer with a small porosity, when the electrode material layer includes a laminated structure”.

As a result, the inventor of the present application has devised an electrode material layer that has an unprecedented novel configuration, rather than the configuration of an electrode material layer including two regions that form a stacked structure as in the prior art (see FIG. 1B).

FIG. 1B is a sectional view schematically illustrating a secondary battery electrode according to an embodiment of the present application.

As shown in FIG. 1B, the inventor of the present application has devised a secondary battery electrode including, rather than an electrode material layer that has a stacked structure composed of two regions (first region and second region), an electrode material layer further including a third region that is higher in porosity than the two regions.

According to an embodiment, the electrode material layer 12 includes at least three regions (a first region 12X, a second region 12Y, and a third region 12Z). Hereinafter, a case where the electrode material layer 12 includes three regions will be described as a premise (see FIG. 1B). The present application is, however, not limited thereto, and the electrode material layer may include more than three regions.

According to an embodiment, the first region 12X is provided on the current collector 11 in a sectional view of the electrode 10. The second region 12Y is provided at least on the first region 12X. In an example, as shown in FIG. 1B, the second region 12Y is also provided on the third region 12Z in addition to first region 12X. More specifically, the second region 12Y is provided so as to cover the first region 12X and the third region 12Z. In addition, the third region 12Z is provided on the current collector 11. More specifically, the first region 12X and the third region 12Z are both provided on the current collector 11.

According to an embodiment, the porosity is increased in the order of the first region 12x, the second region 12Y, and the third region 12Z. It is to be noted that in the present specification, when the electrode material layer has three or more regions, the first region refers to a region with the lowest porosity, whereas the third region refers to a region with the highest porosity.

It is to be noted that in the present specification, of two mutually facing main surfaces of the electrode material layer, the main surface directly facing the current collector is referred to as a “first main surface”, and the main surface opposite to the first main surface is referred to as a “second main surface”. In addition, the feature that “the second region 12Y is provided at least on the first region 12X” as used in the present specification refers to the fact that the second region 12Y is provided so as to be in contact with the main surface of the first region in the stacking direction. The feature that “the first region 12X and the third region 12Z are both provided on the current collector 11” refers to the fact that the first region 12X and the third region 12Z are both provided so as to be in contact with the main surface of the current collector 11.

In accordance with such a configuration, as compared with the configuration of an electrode material layer that has a stacked structure composed of the two regions (first region and second region), the electrode material layer 12 further includes the third region 12Z with the highest in porosity and provided on the current collector 11. Specifically, the third region 12Z can be located in an inner region 12x of the electrode material layer 12 (see FIG. 2). With the electrode assembly 100 immersed in an electrolytic solution 20, the electrolytic solution 20 is less likely to permeate in the inner region 12x of the electrode material layer 12 as compared with an end region 12ß of the electrode material layer 12, because the electrode material layer 12 and the separator 50 directly face each other with a very small gap interposed therebetween.

In this regard, according to an embodiment, the third region 12Z is a region with the highest porosity, thus allowing the third region 12Z to be easily impregnated with the electrolytic solution for ion movements also in the inner region 12x of the electrode material layer 12. Thus, the ion resistance entering the third region 12Z can be reduced as compared with the conventional configuration without the third region 12Z present.

Then, the following technical effects can be produced in ion diffusion sequentially from the second main surface 12b side toward the first main surface 12a side so as to pass through the inner region 12x of the electrode material layer 12 in the stacking (depth) direction at the time of charging and discharging the battery. Specifically, in the electrode material layer 12 on the side where ions enter, the ions can move not only from the second region 12Y to the first region 12x, but also from the second region 12Y to the first region 12X through the third region 12Z “more impregnated with the electrolytic solution for ion movements”.

Such ion movements allow ions to more quickly reach the inside of the first region 12X of the electrode material layer 12 (particularly, the vicinity of the first main surface 12a of the electrode material layer 12 in the first region) from the second main surface 12b side of the electrode material layer 12, as compared with an electrode material layer that has the conventional stacked structure composed of the two regions (first region and second region) without the third region present. Thus, the time of ions can be shortened for reaching the first region 12X of the electrode material layer 12 with the lowest porosity, that is, “the first region 12X, “which is less likely to be impregnated with the electrolytic solution for ion movements”.

As a result, if the electrode material layer 12 employs the stacked structure, an improvement in ion diffusivity (that is, an increase in ion diffusion speed) can be suitably achieved in addition to an improvement in electron conductivity by including the region that is relatively low in porosity. Accordingly, according to an embodiment, the improvement in electron conductivity and the increase in ion diffusion speed allow the energy density and power of the secondary battery 500 to be increased.

A method for manufacturing the secondary battery electrode according to an embodiment will be described below in further detail.

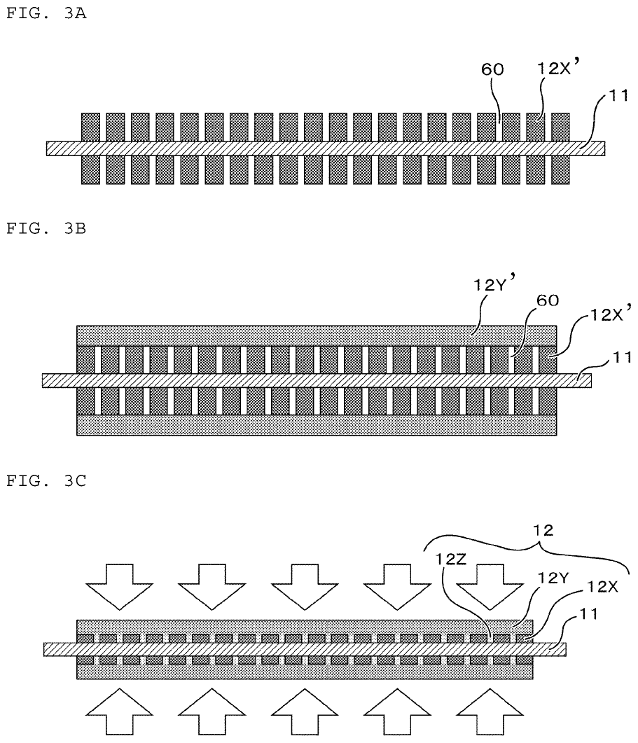

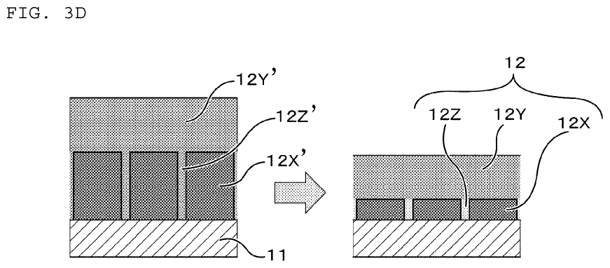

FIG. 3A is a sectional view schematically illustrating a method for manufacturing the secondary battery electrode according to an embodiment (a step of intermittently applying a first electrode material layer slurry). FIG. 3B is a sectional view schematically illustrating the method for manufacturing the secondary battery electrode according to an embodiment (a step of continuously applying a second electrode material layer slurry). FIG. 3C is a sectional view schematically illustrating a method for manufacturing the secondary battery electrode according to an embodiment (a step of forming an electrode material layer). FIG. 3D is an enlarged sectional view schematically illustrating a step of forming the electrode material layer including the third region.

A method for manufacturing the secondary battery electrode according to an embodiment o includes steps of:
(i) preparing the current collector 11;
(ii) providing an electrode material layer slurry on the current collector 11 to form an electrode precursor; and
(iii) drying and pressing the electrode precursor. In particular, according to an embodiment, the step (ii) mentioned above includes: intermittently applying at least two parts of a first electrode material layer slurry 12X′ at a predetermined interval (see FIG. 3A); and continuously applying, on the at least two parts of the first electrode material layer slurry 12X′, a second electrode material layer slurry 12Y′ that is relatively lower in the volume ratio of a solid content containing an active material than the first electrode material layer slurry 12X′ (see FIG. 3B).

According to such a feature, at the time of continuously applying the second electrode material layer slurry 12Y′, a part of the second electrode material layer slurry 12Y′ can enter the uncoated part between the parts of the first electrode material layer slurry 12X′. In this case, the volume ratio of the solid content in the second electrode material layer slurry 12Y′ is relatively lower than that in the first electrode material layer slurry 12X′, and the uncoated part is a local space part without any slurry present. Thus, the volume ratio of the solid content in the electrode material layer slurry entering the uncoated part 60 can be made relatively lower than the volume ratio of the solid content in the second electrode material layer slurry 12Y′ on the first electrode material layer slurry 12X′ (see FIG. 3D). More specifically, a third electrode material layer slurry 12Z′ that is relatively lower in the volume ratio of the solid content than the first electrode material layer slurry 12X′ and the second electrode material layer slurry 12Y′ can be formed on the current collector 11.

As a result, the first electrode material layer slurry 12X′ located on the current collector 11, the second electrode material layer slurry 12Y′ located at least on the first electrode material layer slurry 12X′, and the third electrode material layer slurry 12Z′ located on the current collector 11 can be provided. Thus, an electrode precursor is obtained from the electrode material layer slurries and the current collector in the characteristic arrangement aspect mentioned above. Then, such an electrode precursor is dried and pressed (see FIGS. 3C and 3D). Thus, finally, the secondary battery electrode 10 according to an embodiment can be manufactured (see FIG. 1B).

As for the obtained electrode 10, the electrode material layer 12, which is a constituent element thereof, includes the first region 12X provided on the current collector 11, the second region 12Y provided at least on the first region 12x, and the third region 12Z provided on the current collector 11 in a sectional view. More specifically, the first region 12X and the third region 12Z are both provided on the current collector 11. Furthermore, the first electrode material layer slurry 12X′ to the third electrode material layer slurry 12Z′ is relatively lower in this order in the volume ratio of the solid content, and thus, the obtained first region 12X to third region 12Z are also larger in this order in porosity.

In accordance with such a configuration, as compared with the configuration of an electrode material layer that has a stacked structure composed of the two regions (first region and second region), the electrode material layer 12 further includes the third region 12Z with the highest in porosity and provided on the current collector 11. Thus, at the time of charging and discharging the battery, in the electrode material layer 12 on the side where ions enter, the ions can move not only from the second region 12Y to the first region 12x, but also from the second region 12Y to the first region 12X through the third region 12Z″ impregnated with the electrolytic solution for ion movements”.

Such ion movements allow ions to more quickly reach the inside of the first region 12X of the electrode material layer 12 from the second main surface 12b side of the electrode material layer 12, as compared with an electrode material layer that has the conventional stacked structure composed of the two regions (first region and second region) without the third region present. Thus, the time of ions can be shortened for reaching “the first region 12X, which is less likely to be impregnated with the electrolytic solution for ion movements”. As a result, if the electrode material layer 12 employs the stacked structure, an improvement in electron conductivity and an improvement in ion diffusivity can be suitably achieved.

It is to be noted that an embodiment of the present technology can be used to obtain at least one of the positive electrode and the negative electrode. As an example, the present application can be applied to in a method for manufacturing the negative electrode. From the viewpoint of improving the electron conductivity of the finally obtained electrode and increasing the ion diffusion speed thereof, the manufacturing method according to the present application is preferably applied to both the positive electrode and the negative electrode.

After manufacturing the secondary battery electrode according to an embodiment, an electrode assembly is formed. After forming at least one of the positive electrode and the negative electrode in accordance with the manufacturing method mentioned above, the positive electrode and the negative electrode are stacked with the separator interposed therebetween in the stacking direction to form an electrode constituting layer. When at least two electrode constituting layers are stacked in the stacking direction, a stacked electrode assembly can be finally formed. When a single electrode constituting layer is wound, a wound electrode assembly can be finally formed.

After forming the predetermined electrode assembly (stacked type/wound type), current collecting tabs are welded while the electrode assembly is housed in the exterior body. Next, based on a decompression method, the electrolytic solution is injected into the exterior body. Further, at the time of injecting such an electrolytic solution, the permeation rate of the electrolytic solution into the electrode material layer 12 can be increased as compared with the configuration of the conventional electrode without the third region 12Z, because of the lowest porosity of the third region 12Z of the electrode material layer 12 as compared with the other regions of the electrode material layer.

Through the foregoing steps, a secondary battery including the secondary battery electrode according to an embodiment can be finally obtained.

Further, the secondary battery electrode according to an embodiment preferably employs the following aspects.

In an aspect, the first region 12X and third region 12Z of the electrode material layer 12 are preferably adjacent to each other (see FIG. 1B). In this case, the third region 12Z of the electrode material layer 12 can be disposed so as to fill the space between one first region 12X and the other first region 12X mutually separated while facing.

As described above, according to an embodiment, the presence of the third region 12Z with the highest porosity can achieve an improvement in ion diffusivity. In this regard, according to the present aspect, when the third region 12Z is disposed adjacent to the first region 12X with the lowest porosity, ions can more quickly reach the inside of the first region 12X where ions are most unlikely to enter (particularly, the vicinity of the first main surface 12a of the electrode material layer 12 in the first region), because the third region 12Z is a region where ions are most likely to enter. Thus, the time of ions can be further shortened for reaching the first region 12x where ions are most unlikely to enter, and an improvement in electron conductivity and an improvement in ion diffusivity can be more suitably achieved.

In an aspect, the third region 12Z is preferably located on two or more side parts of the first region 12X located at a predetermined position (see FIG. 1B). In this case, two or more third regions 12Z may be provided at a predetermined interval on the current collector 11.

As described above, according to an embodiment, the presence of the third region 12Z with the highest porosity can achieve an improvement in ion diffusivity. In this regard, according to the present aspect, when the third region 12Z is located on two or more side parts of the first region 12X located at a predetermined position, the number of ion paths can be increased for reaching the inside of the first region 12X at the predetermined position where ions are most unlikely to enter (particularly, the vicinity of the first main surface 12a of the electrode material layer 12 in the first region) from the third region 12Z where ions are most likely to enter. Thus, the time of ions can be more shortened for reaching the first region 12X where ions are most unlikely to enter, and an improvement in electron conductivity and an improvement in ion diffusivity can be still more suitably achieved.

In an aspect, preferably, two or more first regions 12X for the electrode material layer 12 are provided at a predetermined interval on the current collector 11, and the third region 12Z of the electrode material layer 12 is provided so as to fill each space between one of the first regions 12X adjacent to each other and the other first region 12X (see FIG. 1B). In this case, two or more third regions 12Z may be provided at a predetermined interval on the current collector 11.

According to the present aspect, when two or more first regions 12X for the electrode material layer 12 are provided, the third region 12Z is provided so as to fill each space between one of the first regions 12X adjacent to each other and the other first region 12X. In accordance with such a configuration, when two or more first regions 12X are provided, the third region 12Z can be arranged adjacent to each of the first regions 12X.

Such an arrangement allows ions to each suitably reach the inside of each of the first regions 12X where ions are most unlikely to enter, through the third region 12Z where ions are most likely to enter. Thus, the time of ions for reaching the inside of each of the first regions 12X where ions are most unlikely to enter can be more shortened as the whole electrode material layer 12. Accordingly, as a whole, an improvement in electron conductivity and an improvement in ion diffusivity can be more suitably achieved.

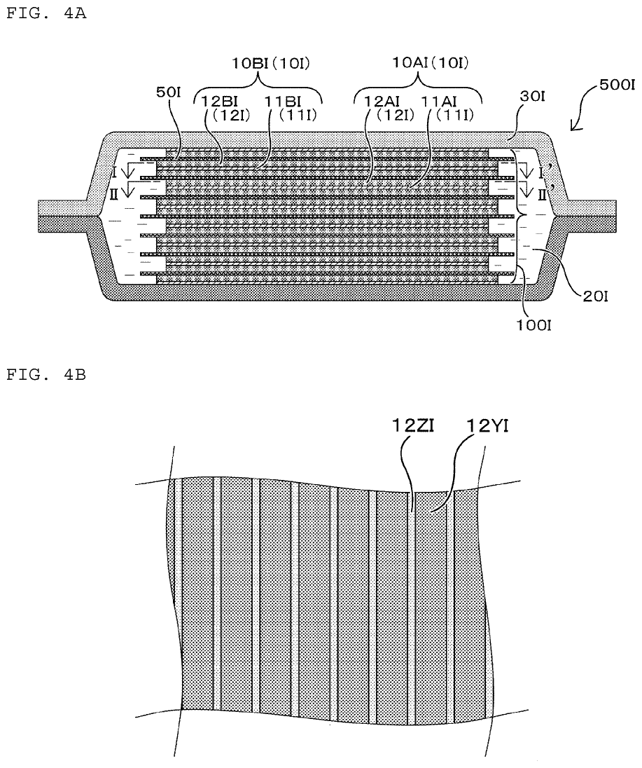

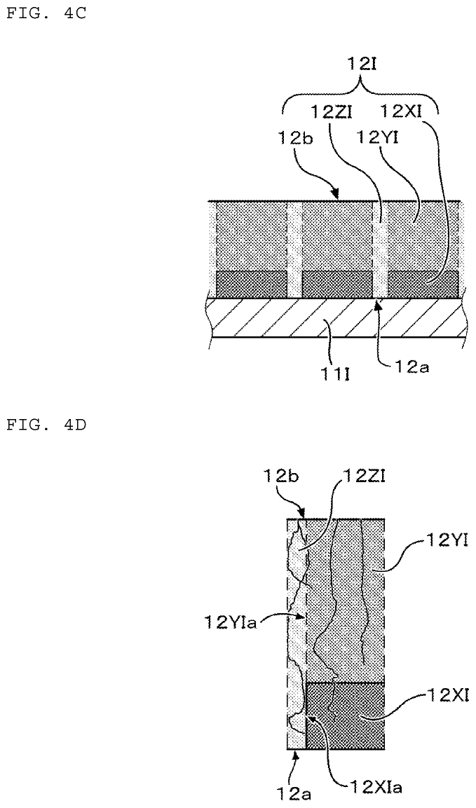

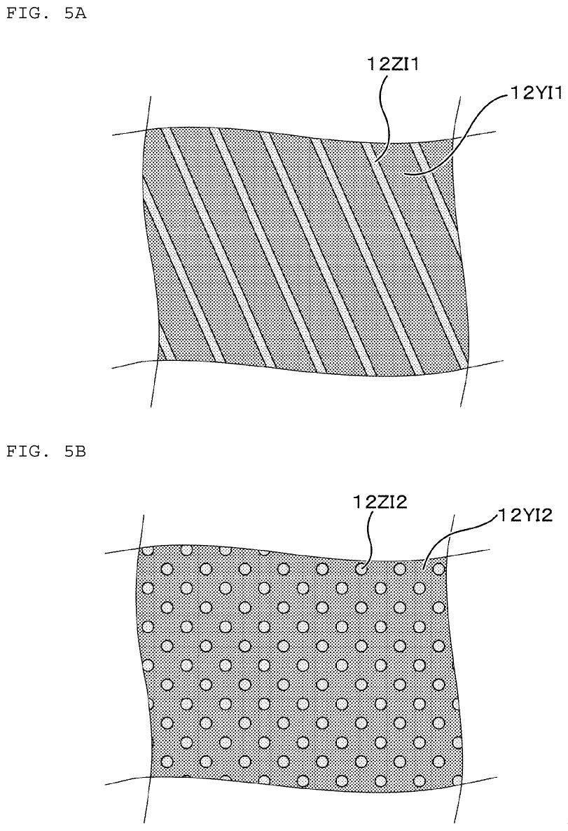

In an aspect, in a sectional view of the electrode, a third region 12ZI of an electrode material layer 12I is preferably provided such that the second main surface 12b of the electrode material layer 12I and a first region 12XI of the electrode material layer 12I are connected to each other via the third region 12ZI (see FIGS. 4A to 4D).

In this case, in the sectional view, the third region 12ZI may extend so as to be in contact with a stacked body including the first region 12XI and a second region 12YI in the stacking direction. More specifically, the third region 12ZI extends so as to cover a side part 12XI1 of the first region 12XI and a side part 12YI1 of the second region 12YI in the stacking direction (see FIGS. 4C and 4D). Specifically, the third region 12ZI may be provided on a current collector 11I so as to extend from the first main surface 12a of the electrode material layer 12I to the second main surface 12b thereof in the stacking direction. In addition, from another viewpoint, the third region 12ZI forms a part of the second main surface 12b of the electrode material layer 12I (see FIG. 4B).

In accordance with such a configuration, one side of the third region 12ZI with the highest porosity will form a part of the second main surface 12b of the electrode material layer 12, with the other side thereof in contact with the first region 12XI. Thus, at the time of charging and discharging the battery, when ions enter the inside from the second main surface 12b of the electrode material layer 12 in the stacking (depth) direction, the ions will enter not only the second region 12YI but also the third region 12ZI. Thus, ions can still more quickly reach the inside of the first region 12XI where ions are most unlikely to enter from the third region 12ZI where ions are most likely to enter. As a result, an improvement in ion diffusivity can be still more suitably achieved.

In an aspect, more preferably, two or more stacked bodies (those including the first region 12XI and the second region 12YI) are provided a at predetermined interval, and each of the third regions 12ZI is provided so as to fill the space between one of the stacked bodies adjacent to each other and the other stacked body (see FIGS. 4B and 4C).

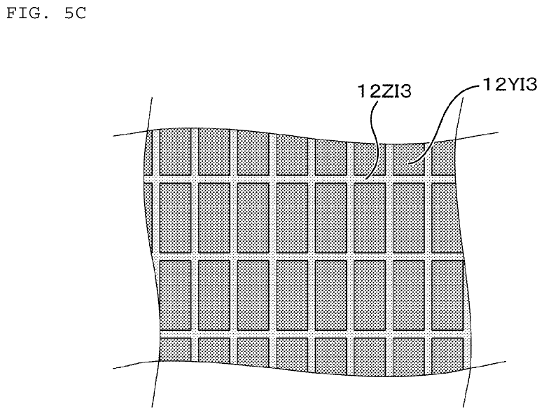

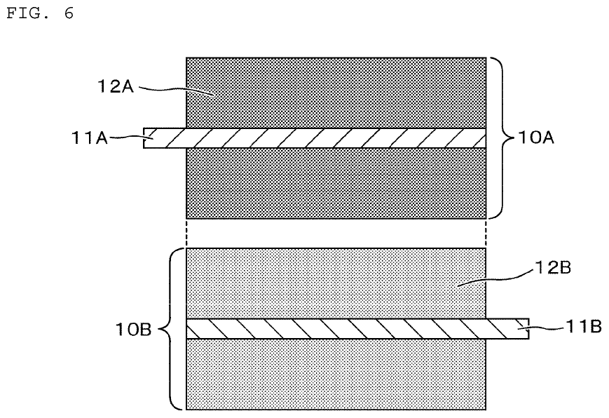

In accordance with such a configuration, the third region 12ZI may be repeatedly provided at predetermined intervals in a plan view (see FIG. 4B). Specifically, the second region 12YI and the third region 12ZI may be alternately arranged in a plan view. Although not particularly limited, as an example of the repetitive arrangement aspect at a predetermined interval, a third region 12ZI1 may have a stripe shape in a plan view (see FIG. 5A). As another example thereof, a third region 12ZI2 may have a dot shape in a plan view (see FIG. 5B). In addition, as still another example thereof, a third region 12ZI3 may have a mesh shape in a plan view (see FIG. 5C).

Such a repetitive arrangement can provide two or more third regions 12ZI formed such that one side thereof forms a part of the second main surface 12b of the electrode material layer 12, whereas the other side has contact with the first region 12XI. Thus, at the time of charging and discharging the battery, when ions enter the inside from the second main surface 12b of the electrode material layer 12 in the stacking (depth) direction, the ions can enter not only the second region 12YI but also the two or more third region 12ZI. As a result, ions can still more quickly reach the inside of the two or more first regions 12XI. Thus, an improvement in ion diffusivity can be still more suitably achieved as the whole electrode material layer 12I.

It is to be noted that, as described herein, the present technology has an advantage in that the presence of the third region with the highest porosity allows ions to quickly reach the first region with the lowest porosity through the third region according to an embodiment. In this regard, when the sectional width size of the third region is relatively large, there is a possibility that the suitable electron conductivity may fail to be suitably secured as the whole electrode material layer, thereby failing to secure the high energy density. In view of such a matter, in the aspect shown in FIGS. 4B and 4C, when the first region 12XI and the second region 12YI have substantially the same width size, the width size of the third region 12ZI and the width size of the stacked body of the first region 12XI and the second region 12YI can be 1:1, preferably 1:2, more preferably 1:5 in the sectional view.

While the present application has been described above according to an embodiment, an example in the applicable scope of the present application has been merely provided, and thus, the present application is not limited thereto, and various modifications can be made.

### EXAMPLES

Examples of the present application will be described below according to an embodiment.

### Example 1

### <Fabricating Step>

First, a current collector made of a copper foil was prepared. Next, electrode material layer slurries (first electrode material layer slurry and second electrode material layer slurry) were prepared.

As the first electrode material layer slurry, the solid content ratio in the slurry was adjusted to be 60% by volume by using, as an active material, an active material that was relatively more likely to be crushed by the same load press in forming the slurry by weighing the active material, a binder, and a conductive auxiliary agent in predetermined proportions and mixing the weighed active material, binder, and conductive auxiliary agent with the solvent. As the second electrode material layer slurry, the solid content ratio in the slurry was adjusted to be 45% by volume by using, as an active material, an active material that was relatively more unlikely to be crushed by the same load press in forming the slurry by weighing the active material, a binder, and a conductive auxiliary agent in predetermined proportions and mixing the weighed active material, binder, and conductive auxiliary agent with the solvent. In Example 1, a negative electrode active material was selected as the active material. Further, Table 1 shows the relationship between the linear pressure and the density on the negative active material that is more unlikely to be crushed and the negative active material that is more likely to be crushed, and FIG. 7 shows the relationship between the linear pressure and the density on the active materials.

TABLE 1

| Linear | Negative Electrode Active | Negative Electrode Active |
|---|---|---|
| Pressure | Material Unlikely to be | Material Likely to be |
| (N/cm) | Crushed (density: g/cm³) | Crushed (density: g/cm³) |
| 3748 | 1.37 | 1.71 |
| 4800 | | 1.78 |
| 5800 | | 1.82 |
| 8852 | 1.52 | 1.88 |

Thereafter, in a simultaneous multilayer coating machine, conditions were set so as to allow intermittently applying the first electrode material layer slurry at predetermined intervals on the current collector and continuously applying the second electrode material layer slurry on the first electrode material layer slurry intermittently applied, and to reach 160 μm in the coating thickness of the electrode material layer slurry. The conditions for intermittently applying the first electrode material layer slurry were set such that the coating distance was 5 mm, whereas the uncoating distance was 5 mm. After setting such conditions, the intermittent application of the first electrode material layer slurry and the continuous application of the second electrode material layer slurry were simultaneously performed with the use of the simultaneous multilayer coating machine.

The continuous application of the second electrode material layer slurry caused the second electrode material layer slurry to enter the uncoated part between the parts of the first electrode material layer slurry. Thus, the volume ratio of the solid content including the active material in the electrode material layer slurry located in the uncoated part can be made relatively lower than the volume ratio of the solid content including the active material in the second electrode material layer slurry on the first electrode material layer slurry. As described above, an electrode precursor was formed, which was composed of the three types of electrode material layer slurry that were different in the solid content ratio in the slurry.

After the formation of the electrode precursor, the electrode precursor was subjected to drying, and then pressing so as to have a predetermined electrode thickness. After the pressing, an electrode precursor (corresponding to an electrode sheet) was subjected to punching into a diameter of 16.5 mm. As described above, an electrode (negative electrode) including the electrode material layer composed of the three regions was formed. Specifically, in the case of the electrode (negative electrode) including the electrode material layer composed of the three regions, the first region is provided on the current collector, the second region is provided on the first region, and the third region is provided on the current collector. Specifically, the third region was provided such that the second main surface (corresponding to the main surface opposite to the main surface directly facing the current collector) of the electrode material layer and the first region were connected to each other via the third region.

After the formation of the electrode (negative electrode), a counter electrode (positive electrode) was prepared. The counter electrode (positive electrode) was obtained by continuously applying a positive electrode material layer slurry onto a current collector (copper foil) so as to reach the same thickness (160 μm) as mentioned above.

After the formation of the positive electrode and the negative electrode, the positive electrode and the negative electrode were stacked with a separator interposed therebetween in the stacking direction to form an electrode assembly. As the separator, a polyethylene porous membrane was used. After the formation of the electrode assembly, current collecting tabs were welded while the electrode assembly was housed in an exterior body. Next, based on a decompression method, the electrolytic solution was injected into the exterior body. As the electrolytic solution, an organic electrolytic solution was used, which was obtained by dissolving a lithium hexafluorophosphate (LiPF₆) at 1 mol per liter of solvent in a solvent with EC:EMC of 1:3 in ratio by weight.

A secondary battery (coin cell of 20 mm in diameter/1.6 mm in thickness) including the electrode according to an embodiment was fabricated mainly through the foregoing steps.

### <Content of Calculation/Measurement and Results Thereof>

The obtained electrode itself and the secondary battery including the electrode were evaluated for the following contents.

### (1) Porosity of Each Electrode Material Layer+Area Ratio of Void Part (%)

For the three regions of the formed electrode (negative electrode), the porosity for each of the regions was calculated from the area density (mg/cm²) and the volume density (mg/cm³). Furthermore, the area ratio (%) of the void part was calculated in binarization of an SEM image of the evaluated electrode section with free image analysis software Image J. The results are shown in Table 2.

### (2) Discharge Rate Retention Ratio+Discharge Cycle Retention Ratio (%)

The secondary battery was initially charged and discharged in a voltage range from 0.01 to 2.0 V at a current value of 0.1 C in a thermostatic chamber at 25° C., and then charged and discharged twice at 0.5° C. to be stabilized. Subsequently, the battery was charged at 0.5 C up to a voltage range of 0.01 V, and then discharged once at 0.2 C. Next, the battery was charged at 0.5 C up to a voltage range of 0.01 V, and then discharged once at 2.0 C. From the discharge capacity retention ratio at 2.0° C. with respect to 0.2 C in this case, the discharge rate retention ratio (%) was calculated. Thereafter, the charge-discharge cycle of 0.5 C to 2.0 C was repeated 100 times, and the discharge cycle retention ratio (%) was calculated from the discharge capacity retention ratio in the 100th cycle with respect to the discharge capacity in the first cycle. The results are shown in Table 2.

### (3) Electrolytic Solution Impregnability in Electrode

The obtained electrode (negative electrode) was subjected to punching into a diameter of 20 mm, and then 1 μL of PC was dropped onto the electrode surface with the use of a syringe. The time from immediately after the dropwise addition until complete permeation of the PC into the electrode was measured with a stopwatch. The result is shown in Table 3.

As shown in Table 2, in the case of the electrode (negative electrode) including the electrode material layer composed of the three regions, the lowest porosity was obtained for the first region located at predetermined positions on the current collector/the lowest area ratio was obtained for the void part. In contrast, the highest porosity has been found to be obtained for the third region located at the other positions on the current collector/the highest area ratio was obtained for the void part. Specifically, the highest porosity has been found to be obtained for the third region in contact with the stacked body including the first region and the second region. Under the conditions, as shown in Table 2, the discharge rate retention ratio was 78.0%, and the discharge cycle retention ratio was 85.2%, and both the highest retention ratios have been found to be obtained. More specifically, the best battery characteristics have been found to be obtained. Further, under such conditions, as shown in Table 3, the permeation time of the electrolytic solution in the electrode was 40 s, which was the shortest time, and the best electrolytic solution impregnability has been found to be obtained.

### Example 2

### <Fabricating Step>

As in Example 1, a current collector made of a copper foil was prepared. Next, electrode material layer slurries (first electrode material layer slurry and second electrode material layer slurry) were prepared.

As the first electrode material layer slurry, the solid content ratio in the slurry was adjusted to be 60% by volume by relatively increasing the ratio of a binder in forming the slurry by weighing an active material, the binder, and a conductive auxiliary agent in predetermined proportions and mixing the weighed active material, binder, and conductive auxiliary agent with the solvent. As the second electrode material layer slurry, the solid content ratio in the slurry was adjusted to be 45% by volume by relatively decreasing the ratio of a binder in forming the slurry by weighing an active material, the binder, and a conductive auxiliary agent in predetermined proportions and mixing the weighed active material, binder, and conductive auxiliary agent with the solvent. Also in Example 2, a negative electrode active material was selected as the active material.

Thereafter, in a simultaneous multilayer coating machine, conditions were set so as to allow intermittently applying the first electrode material layer slurry at predetermined intervals on the current collector and continuously applying the second electrode material layer slurry on the first electrode material layer slurry intermittently applied, and to reach 140 μm in the coating thickness of the electrode material layer slurry. The conditions for intermittently applying the first electrode material layer slurry were set such that the coating distance was 5 mm, whereas the uncoating distance was 5 mm. After setting such conditions, the intermittent application of the first electrode material layer slurry and the continuous application of the second electrode material layer slurry were simultaneously performed with the use of the simultaneous multilayer coating machine.

Thus, an electrode precursor was formed, which was composed of the three types of electrode material layer slurry that were mutually different in the solid content ratio in the slurry. Thereafter, the electrode precursor was subjected to drying and pressing under the same conditions by the same methods as in Example 1, and subjected to punching to form an electrode (negative electrode) including an electrode material layer composed of three regions. Furthermore, a secondary battery (coin cell of 20 mm in diameter/1.6 mm in thickness) including the electrode according to an embodiment was finally fabricated through the steps of forming a counter electrode (positive electrode), forming an electrode assembly, housing the electrode assembly in an exterior body, and injecting an electrolytic solution into the exterior body under the same conditions by the same methods as in Example 1.

### <Content of Calculation/Measurement and Results Thereof>

The obtained electrode itself and the secondary battery including the electrode were evaluated for (1) the porosity for each of the regions of the electrode material layer, (2) the discharge rate retention ratio+the discharge cycle retention ratio (%), and (3) the electrolytic solution impregnability in the electrode under the same conditions and by the same method as in Example 1. The results thereof are shown in Table 2 and Table 3.

As shown in Table 2, in the case of the electrode (negative electrode) including the electrode material layer composed of the three regions, the lowest area ratio of the porosity was obtained for the first region located at predetermined positions on the current collector. In contrast, the highest area ratio of the porosity has been found to be obtained for the third region located at the other positions on the current collector. Specifically, the highest porosity has been found to be obtained for the third region in contact with the stacked body including the first region and the second region. Under such conditions, as shown in Table 2, the discharge rate retention ratio+the discharge cycle retention ratio (%) exceeded 70% of a predetermined standard as compared with a comparative example, and the battery characteristics have been found to be good. Furthermore, under such conditions, as shown in Table 3, the permeation time of the electrolytic solution in the electrode was shorter than that in the comparative example, and the electrolytic solution impregnability has been to be improved.

### Example 3

### <Fabricating Step>

As in Example 1 and Example 2, a current collector made of a copper foil was prepared. Next, electrode material layer slurries (first electrode material layer slurry and second electrode material layer slurry) were prepared.

As the first electrode material layer slurry, the solid content ratio in the slurry was adjusted to be 60% by volume by relatively increasing the ratio of a conductive auxiliary agent in forming the slurry by weighing an active material, a binder, and the conductive auxiliary agent in predetermined proportions and mixing the weighed active material, binder, and conductive auxiliary agent with the solvent. As the second electrode material layer slurry, the solid content ratio in the slurry was adjusted to be 50% by volume by relatively decreasing the ratio of a conductive auxiliary agent in forming the slurry by weighing an active material, a binder, and the conductive auxiliary agent in predetermined proportions and mixing the weighed active material, binder, and conductive auxiliary agent with the solvent. Also in Example 3, a negative electrode active material was selected as the active material.

Thereafter, in a simultaneous multilayer coating machine, conditions were set so as to allow intermittently applying the first electrode material layer slurry at predetermined intervals on the current collector and continuously applying the second electrode material layer slurry on the first electrode material layer slurry intermittently applied, and to reach 140 μm in the coating thickness of the electrode material layer slurry. The conditions for intermittently applying the first electrode material layer slurry were set such that the coating distance was 5 mm, whereas the uncoating distance was 5 mm. After setting such conditions, the intermittent application of the first electrode material layer slurry and the continuous application of the second electrode material layer slurry were simultaneously performed with the use of the simultaneous multilayer coating machine.

Thus, an electrode precursor was formed, which was composed of the three types of electrode material layer slurry that were mutually different in the solid content ratio in the slurry. Thereafter, the electrode precursor was subjected to drying and pressing under the same conditions by the same methods as in Example 1 and Example 2, and subjected to punching to form an electrode (negative electrode) including an electrode material layer composed of three regions. Furthermore, a secondary battery (coin cell of 20 mm in diameter/1.6 mm in thickness) including the electrode according to an embodiment was finally fabricated through the steps of forming a counter electrode (positive electrode), forming an electrode assembly, housing the electrode assembly in an exterior body, and injecting an electrolytic solution into the exterior body under the same conditions by the same methods as in Example 1 and Example 2.

### <Content of Calculation/Measurement and Results Thereof>

The obtained electrode itself and the secondary battery including the electrode were evaluated for (1) the porosity for each of the regions of the electrode material layer, (2) the discharge rate retention ratio+the discharge cycle retention ratio (%), and (3) the electrolytic solution impregnability in the electrode under the same conditions and by the same method as in Example 1 and Example 2. The results thereof are shown in Table 2 and Table 3.

As shown in Table 2, in the case of the electrode (negative electrode) including the electrode material layer composed of the three regions, the lowest area ratio of the porosity was obtained for the first region located at predetermined positions on the current collector. In contrast, the highest area ratio of the porosity has been found to be obtained for the third region located at the other positions on the current collector. Specifically, the highest porosity has been found to be obtained for the third region in contact with the stacked body including the first region and the second region. Under such conditions, as shown in Table 2, the discharge rate retention ratio+the discharge cycle retention ratio (%) exceeded 70% of a predetermined standard as compared with a comparative example, and the battery characteristics have been found to be good. Furthermore, under such conditions, as shown in Table 3, the permeation time of the electrolytic solution in the electrode was shorter than that in the comparative example, and the electrolytic solution impregnability has been to be improved.

Comparative examples will be described below.

### Comparative Example 1

Comparative Example 1 is different from Example 1 in that only the first electrode material layer slurry in Example 1 is used as the electrode material layer slurry.

### <Fabricating Step>

First, a current collector made of a copper foil was prepared. Next, the electrode material layer slurry was prepared.

As the electrode material layer slurry, the solid content ratio in the slurry was adjusted to be 60% by volume by using the same active material as that used in the first electrode material layer slurry according to Example 1, specifically, the active material that was relatively more likely to be crushed in forming the slurry by weighing the active material, a binder, and a conductive auxiliary agent in predetermined proportions and mixing the weighed active material, binder, and conductive auxiliary agent with the solvent. In Comparative Example 1, a negative electrode active material was selected as the active material.

Thereafter, in a coating machine, conditions were set to perform single continuous application of the electrode material layer slurry on the current collector, and to reach 160 μm in the coating thickness of the electrode material layer slurry. After setting such conditions, the single continuous coating of the electrode material layer slurry was performed with the use of the coating machine. As described above, an electrode precursor including the electrode material layer slurry with the solid content ratio in the slurry being 60% by volume was formed.

Thereafter, the electrode precursor was subjected to drying and pressing under the same conditions by the same methods as in Example 1, and subjected to punching to form an electrode (negative electrode) including the current collector an electrode material layer. Furthermore, a secondary battery (coin cell of 20 mm in diameter/1.6 mm in thickness) including the electrode including the electrode material layer of the single-layer structure was finally fabricated through the steps of forming a counter electrode (positive electrode), forming an electrode assembly, housing the electrode assembly in an exterior body, and injecting an electrolytic solution into the exterior body under the same conditions by the same methods as in Example 1.

### <Content of Calculation/Measurement and Results Thereof>

The obtained electrode itself and the secondary battery including the electrode were evaluated for (1) the porosity of the electrode material layer and the area ratio of the void part (%), (2) the discharge rate retention ratio+the discharge cycle retention ratio (%), and (3) the electrolytic solution impregnability in the electrode under the same conditions and by the same method as in Example 1. The results thereof are shown in Table 2 and Table 3.

As shown in Table 2, the porosity of the electrode material layer of the electrode (negative electrode) and the area ratio (%) of void part have been found to be close to the values of the first region of the electrode material layer in Example 1. Under this conditions, as shown in Table 2, the discharge rate retention ratio+the discharge cycle retention ratio (%) fell below 70% of a predetermined standard as compared with Examples 1 to 3, and the battery characteristics have been found to be poor. Furthermore, under such conditions, as shown in Table 3, the permeation time of the electrolytic solution in the electrode was about 1.6 times to about 2.0 times as long as that in Examples 1 to 3, and the electrolytic solution impregnability has been to be poor.

### Comparative Example 2

Comparative Example 2 is different from Example 1 in that only the second electrode material layer slurry in Example 1 is used as the electrode material layer slurry.

### <Fabricating Step>

A current collector made of a copper foil was prepared. Next, the electrode material layer slurry was prepared.

Specifically, as the electrode material layer slurry, the solid content ratio in the slurry was adjusted to be 45% by volume by using the same active material as that used in the second electrode material layer slurry according to Example 1, specifically, the active material that was relatively more unlikely to be crushed in forming the slurry by weighing the active material, a binder, and a conductive auxiliary agent in predetermined proportions and mixing the weighed active material, binder, and conductive auxiliary agent with the solvent. In Comparative Example 2, a negative electrode active material was selected as the active material.

Thereafter, single continuous application of the electrode material layer slurry for a coating thickness of 160 μm was performed with the use of a coating machine in the same manner as in Comparative Example 1. As described above, an electrode precursor including the electrode material layer slurry with the solid content ratio in the slurry being 45% by volume was formed.

Thereafter, the electrode precursor was subjected to drying and pressing under the same conditions by the same methods as in Example 1, and subjected to punching to form an electrode (negative electrode) including the current collector an electrode material layer. Furthermore, a secondary battery (coin cell of 20 mm in diameter/1.6 mm in thickness) including the electrode including the electrode material layer of the single-layer structure was finally fabricated through the steps of forming a counter electrode (positive electrode), forming an electrode assembly, housing the electrode assembly in an exterior body, and injecting an electrolytic solution into the exterior body under the same conditions by the same methods as in Example 1.

### <Content of Calculation/Measurement and Results Thereof>

The obtained electrode itself and the secondary battery including the electrode were evaluated for (1) the porosity of the electrode material layer and the area ratio of the void part (%), (2) the discharge rate retention ratio+the discharge cycle retention ratio (%), and (3) the electrolytic solution impregnability in the electrode under the same conditions and by the same method as in Example 1. The results thereof are shown in Table 2 and Table 3.

As shown in Table 2, the porosity of the electrode material layer of the electrode (negative electrode) and the area ratio (%) of void part have been found to be close to the values of the second region of the electrode material layer in Example 1. As shown in Table 2, the discharge rate retention ratio+the discharge cycle retention ratio (%) fell below 70% of a predetermined standard as compared with Examples 1 to 3, and the battery characteristics have been found to be poor. Furthermore, under such conditions, as shown in Table 3, the permeation time of the electrolytic solution in the electrode was about 1.5 times to about 1.8 times as long as that in Examples 1 to 3, and the electrolytic solution impregnability has been to be poor.

### Comparative Example 3

Comparative Example 3 is the same in that the first electrode material layer slurry and the second electrode material layer slurry in Example 1 are used as the electrode material layer slurry. In contrast, Comparative Example 3 is different from Example 1 in that the first electrode material layer slurry and the second electrode material layer slurry are both continuously applied.

### <Fabricating Step>

First, a current collector made of a copper foil was prepared. Next, electrode material layer slurries (first electrode material layer slurry and second electrode material layer slurry) were prepared.

As in Example 1, as the first electrode material layer slurry, the solid content ratio in the slurry was adjusted to be 60% by volume by using, as an active material, an active material that was relatively more likely to be crushed by the same load press in forming the slurry by weighing the active material, a binder, and a conductive auxiliary agent in predetermined proportions and mixing the weighed active material, binder, and conductive auxiliary agent with the solvent. As the second electrode material layer slurry, the solid content ratio in the slurry was adjusted to be 45% by volume by using, as an active material, an active material that was relatively more unlikely to be crushed by the same load press in forming the slurry by weighing the active material, a binder, and a conductive auxiliary agent in predetermined proportions and mixing the weighed active material, binder, and conductive auxiliary agent with the solvent. In Comparative Example 3, a negative electrode active material was selected as the active material.

Thereafter, in a simultaneous multilayer coating machine, conditions were set so as to allow continuously applying the first electrode material layer slurry on the current collector and continuously applying the second electrode material layer slurry on the first electrode material layer slurry, and to reach 160 μm in the coating thickness of the electrode material layer slurry. After setting such conditions, the continuous application of the first electrode material layer slurry and the continuous application of the second electrode material layer slurry were simultaneously performed with the use of the simultaneous multilayer coating machine.

As described above, an electrode precursor including the two types of electrode material layer slurry that were different in the solid content ratio in the slurry was formed.

Thereafter, the electrode precursor was subjected to drying and pressing under the same conditions by the same methods as in Example 1, and subjected to punching to form an electrode (negative electrode) including the current collector an electrode material layer. Furthermore, a secondary battery (coin cell of 20 mm in diameter/1.6 mm in thickness) including the electrode including the electrode material layer composed of the two regions of the stacked structure was finally fabricated through the steps of forming a counter electrode (positive electrode), forming an electrode assembly, housing the electrode assembly in an exterior body, and injecting an electrolytic solution into the exterior body under the same conditions by the same methods as in Example 1.

### <Content of Calculation/Measurement and Results Thereof>

The obtained electrode itself and the secondary battery including the electrode were evaluated for (1) the porosity for each of the two regions and the area ratio of the void part (%), (2) the discharge rate retention ratio+the discharge cycle retention ratio (%), and (3) the electrolytic solution impregnability in the electrode under the same conditions and by the same method as in Example 1. The results thereof are shown in Table 2 and Table 3.

As shown in Table 2, the porosity of the first region of the electrode material layer of the electrode (negative electrode) and the area ratio (%) of void part have been found to be close to the values of the first region in Example 1. In addition, the porosity of the second region of the electrode material layer of the electrode (negative electrode) and the area ratio (%) of void part have been found to be substantially equal to the values of the second region in Example 1. Under such conditions, as shown in Table 2, the discharge rate retention ratio+the discharge cycle retention ratio (%) have been found below 70% of a predetermined standard as compared with Examples 1 to 3. Furthermore, under such conditions, as shown in Table 3, the permeation time of the electrolytic solution in the electrode was 80 s, which was the longest time, and was about 1.7 times to about 2.0 times as long as that in Examples 1 to 3. From the foregoing, the worst electrolytic solution impregnability has been found to be obtained.

### Comparative Example 4

Comparative Example 4 is the same in that the first electrode material layer slurry and the second electrode material layer slurry in Example 2 are used as the electrode material layer slurry. In contrast, Comparative Example 4 is different from Example 2 in that the first electrode material layer slurry and the second electrode material layer slurry are both continuously applied.

### <Fabricating Step>

First, a current collector made of a copper foil was prepared. Next, electrode material layer slurries (first electrode material layer slurry and second electrode material layer slurry) were prepared.

Specifically, as in Example 2, as the first electrode material layer slurry, the solid content ratio in the slurry was adjusted to be 60% by volume by relatively increasing the ratio of a binder in forming the slurry by weighing an active material, the binder, and a conductive auxiliary agent in predetermined proportions and mixing the weighed active material, binder, and conductive auxiliary agent with the solvent. As the second electrode material layer slurry, the solid content ratio in the slurry was adjusted to be 45% by volume by relatively decreasing the ratio of a binder in forming the slurry by weighing an active material, the binder, and a conductive auxiliary agent in predetermined proportions and mixing the weighed active material, binder, and conductive auxiliary agent with the solvent. In Comparative Example 4, a negative electrode active material was selected as the active material.

Thereafter, in a simultaneous multilayer coating machine, conditions were set so as to allow continuously applying the first electrode material layer slurry on the current collector and continuously applying the second electrode material layer slurry on the first electrode material layer slurry, and to reach 140 μm in the coating thickness of the electrode material layer slurry. After setting such conditions, the continuous application of the first electrode material layer slurry and the continuous application of the second electrode material layer slurry were simultaneously performed with the use of the simultaneous multilayer coating machine.

As described above, an electrode precursor including the two types of electrode material layer slurry that were different in the solid content ratio in the slurry was formed.

Thereafter, the electrode precursor was subjected to drying and pressing under the same conditions by the same methods as in Example 2, and subjected to punching to form an electrode (negative electrode) including the current collector an electrode material layer. Furthermore, a secondary battery (coin cell of 20 mm in diameter/1.6 mm in thickness) including the electrode including the electrode material layer composed of the two regions of the stacked structure was finally fabricated through the steps of forming a counter electrode (positive electrode), forming an electrode assembly, housing the electrode assembly in an exterior body, and injecting an electrolytic solution into the exterior body under the same conditions by the same methods as in Example 2.

### <Content of Calculation/Measurement and Results Thereof>

The obtained electrode itself and the secondary battery including the electrode were evaluated for (1) the porosity for each of the two regions (%), (2) the discharge rate retention ratio+the discharge cycle retention ratio (%), and (3) the electrolytic solution impregnability in the electrode under the same conditions and by the same method as in Example 2. The results thereof are shown in Table 2 and Table 3.

As shown in Table 2, the porosity of the first region of the electrode material layer of the electrode (negative electrode) has been found to have the same value as that of the first region in Example 2. The porosity of the second region of the electrode (negative electrode) has been found to be slightly higher than that of the second region in Example 2. Under such conditions, as shown in Table 2, the discharge rate retention ratio+the discharge cycle retention ratio (%) have been found below 70% of a predetermined standard as compared with Examples 1 to 3. Furthermore, under such conditions, as shown in Table 3, the permeation time of the electrolytic solution in the electrode was about 1.4 times to about 1.7 times as long as that in Examples 1 to 3. From the foregoing, the electrolytic solution impregnability has been found to be poor.

### Comparative Example 5

Comparative Example 5 is the same in that the first electrode material layer slurry and the second electrode material layer slurry in Example 3 are used as the electrode material layer slurry. In contrast, Comparative Example 5 is different from Example 3 in that the first electrode material layer slurry and the second electrode material layer slurry are both continuously applied.

### <Fabricating Step>

First, a current collector made of a copper foil was prepared. Next, electrode material layer slurries (first electrode material layer slurry and second electrode material layer slurry) were prepared.

Specifically, as in Example 3, as the first electrode material layer slurry, the solid content ratio in the slurry was adjusted to be 60% by volume by relatively increasing the ratio of a conductive auxiliary agent in forming the slurry by weighing an active material, a binder, and the conductive auxiliary agent in predetermined proportions and mixing the weighed active material, binder, and conductive auxiliary agent with the solvent. As the second electrode material layer slurry, the solid content ratio in the slurry was adjusted to be 50% by volume by relatively decreasing the ratio of a conductive auxiliary agent in forming the slurry by weighing an active material, a binder, and the conductive auxiliary agent in predetermined proportions and mixing the weighed active material, binder, and conductive auxiliary agent with the solvent. In Comparative Example 5, a negative electrode active material was selected as the active material.

Thereafter, in a simultaneous multilayer coating machine, conditions were set so as to allow continuously applying the first electrode material layer slurry on the current collector and continuously applying the second electrode material layer slurry on the first electrode material layer slurry, and to reach 140 μm in the coating thickness of the electrode material layer slurry. After setting such conditions, the continuous application of the first electrode material layer slurry and the continuous application of the second electrode material layer slurry were simultaneously performed with the use of the simultaneous multilayer coating machine.

As described above, an electrode precursor including the two types of electrode material layer slurry that were different in the solid content ratio in the slurry was formed.

Thereafter, the electrode precursor was subjected to drying and pressing under the same conditions by the same methods as in Example 3, and subjected to punching to form an electrode (negative electrode) including the current collector an electrode material layer. Furthermore, a secondary battery (coin cell of 20 mm in diameter/1.6 mm in thickness) including the electrode including the electrode material layer composed of the two regions of the stacked structure was finally fabricated through the steps of forming a counter electrode (positive electrode), forming an electrode assembly, housing the electrode assembly in an exterior body, and injecting an electrolytic solution into the exterior body under the same conditions by the same methods as in Example 3.

### <Content of Calculation/Measurement and Results Thereof>

The obtained electrode itself and the secondary battery including the electrode were evaluated for (1) the porosity for each of the two regions (%), (2) the discharge rate retention ratio+the discharge cycle retention ratio (%), and (3) the electrolytic solution impregnability in the electrode under the same conditions and by the same method as in Example 3. The results thereof are shown in Table 2 and Table 3.

As shown in Table 2, the porosity of the first region of the electrode material layer of the electrode (negative electrode) has been found to have the same value as that of the first region in Example 3. The porosity of the second region of the electrode material layer of the electrode (negative electrode) has been found to be slightly higher than that of the second electrode material layer in Example 3. As shown in Table 2, the discharge rate retention ratio+the discharge cycle retention ratio (%) have been found below 70% of a predetermined standard as compared with Examples 1 to 3, and about 60%. Furthermore, under such conditions, as shown in Table 3, the permeation time of the electrolytic solution in the electrode was about 1.4 times to about 1.7 times as long as that in Examples 1 to 3. From the foregoing, the electrolytic solution impregnability has been found to be poor.

### Comparative Example 6

Comparative Example 6 is the same as Example 1 in that the first electrode material layer slurry and the second electrode material layer slurry in Example 1 are used as the electrode material layer slurry, and that the intermittent application of the first electrode material layer slurry and the continuous application of the second electrode material layer slurry are performed. In contrast, Comparative Example 6 is different from Example 1 in that the first electrode material layer slurry includes an active material that is relatively more unlikely to be crushed, and that the second electrode material layer slurry includes an active material that is relatively more likely to be crushed.

### <Fabricating Step>

First, a current collector made of a copper foil was prepared. Next, electrode material layer slurries (first electrode material layer slurry and second electrode material layer slurry) were prepared.

As the first electrode material layer slurry, the solid content ratio in the slurry was adjusted to be 45% by volume by using, as an active material, an active material that was relatively more unlikely to be crushed by the same load press in forming the slurry by weighing the active material, a binder, and a conductive auxiliary agent in predetermined proportions and mixing the weighed active material, binder, and conductive auxiliary agent with the solvent. As the second electrode material layer slurry, the solid content ratio in the slurry was adjusted to be 60% by volume by using, as an active material, an active material that was relatively more likely to be crushed by the same load press in forming the slurry by weighing the active material, a binder, and a conductive auxiliary agent in predetermined proportions and mixing the weighed active material, binder, and conductive auxiliary agent with the solvent. In Comparative Example 6, a negative electrode active material was selected as the active material.

Thereafter, in a simultaneous multilayer coating machine, conditions were set so as to allow intermittently applying the first electrode material layer slurry at predetermined intervals on the current collector and continuously applying the second electrode material layer slurry on the first electrode material layer slurry intermittently applied, and to reach 160 μm in the coating thickness of the electrode material layer slurry. The conditions for intermittently applying the first electrode material layer slurry were set such that the coating distance was 5 mm, whereas the uncoating distance was 5 mm. After setting such conditions, the intermittent application of the first electrode material layer slurry and the continuous application of the second electrode material layer slurry were simultaneously performed with the use of the simultaneous multilayer coating machine.

In the continuous application of the second electrode material layer slurry, the second electrode material layer slurry has a higher solid content ratio than the first electrode material layer slurry, further in combination with the action of the gravity, and thus, the solid content can enter, in a larger amount, the gap part located at the uncoated part. Thus, the volume ratio of the solid content including the active material in the electrode material layer slurry located in the uncoated part can be relatively higher than the volume ratio of the solid content including the active material in the second electrode material layer slurry on the first electrode material layer slurry. Thus, as described later, according to Comparative Example 6, the porosities of the first region, second region, and third region can be decreased in this order as for the electrode material layer of the finally obtained electrode. As described above, an electrode precursor including the three types of electrode material layer slurry that were mutually different in the solid content ratio in the slurry was formed.

After the formation of the electrode precursor, the electrode precursor was subjected to drying, and then pressing so as to have a predetermined electrode thickness. After the pressing, an electrode precursor (corresponding to an electrode sheet) was subjected to punching into a diameter of 16.5 mm. As described above, an electrode (negative electrode) including the electrode material layer composed of the three regions was formed. Specifically, in the case of the electrode (negative electrode) including the electrode material layer composed of the three regions, the first region is provided on the current collector, the second region is provided on the first region, and the third region is provided on the current collector. Specifically, the third region was provided such that the second main surface (corresponding to the main surface opposite to the main surface directly facing the current collector) of the electrode material layer and the first region were connected to each other via the third region.

Thereafter, the electrode precursor was subjected to drying and pressing under the same conditions by the same methods as in Example 1, and subjected to punching to form an electrode (negative electrode) including the current collector an electrode material layer. Furthermore, a secondary battery (coin cell of 20 mm in diameter/1.6 mm in thickness) including the electrode was finally fabricated through the steps of forming a counter electrode (positive electrode), forming an electrode assembly, housing the electrode assembly in an exterior body, and injecting an electrolytic solution into the exterior body under the same conditions by the same methods as in Example 1.

### <Content of Calculation/Measurement and Results Thereof>

The obtained electrode itself and the secondary battery including the electrode were evaluated for (1) the porosity for each of the regions of the electrode material layer and the area ratio of the void part (%), (2) the discharge rate retention ratio+the discharge cycle retention ratio (%), and (3) the electrolytic solution impregnability in the electrode under the same conditions and by the same method as in Example 1. The results thereof are shown in Table 2 and Table 3.

As shown in Table 2, the magnitude relationship between the porosity for each region of the electrode material layer of the electrode (negative electrode) and the area ratio (%) of the void part was reverse to that in Example 1. Specifically, in Example 1, the porosities of the first region, second region, the third region were higher in this order. In contrast, the porosities of the first region, second region, and third region have been found to be lower in this order in Comparative Example 6. Under this condition, as shown in Table 2, the discharge rate retention ratio was 53.8%, which has been found to be the lowest ratio among the following in Example 1 to Comparative Example 7 described later. In addition, the discharge cycle retention ratio (%) has been found below 70% of a predetermined standard as compared with Examples 1 to 3, and about 60%. Furthermore, under such conditions, as shown in Table 3, the permeation time of the electrolytic solution in the electrode was about 1.15 times to about 1.4 times as long as that in Examples 1 to 3. From the foregoing, the electrolytic solution impregnability has been found to be poor as compared with those in Examples 1 to 3.

### Comparative Example 7

Comparative Example 7 is, as in Comparative Example 6, the same as Example 1 in that the first electrode material layer slurry and the second electrode material layer slurry in Example 1 are used as the electrode material layer slurry, and that the intermittent application of the first electrode material layer slurry and the continuous application of the second electrode material layer slurry are performed. In contrast, Comparative Example 7 is, as in Comparative Example 6, different from Example 1 in that the first electrode material layer slurry includes an active material that is relatively more unlikely to be crushed, and that the second electrode material layer slurry includes an active material that is relatively more likely to be crushed. Furthermore, Comparative Example 7 is different from Comparative Example 6 only in that the solid content ratio in the second electrode material layer slurry is 52.5% by volume instead of 60% by volume. Thus, the description of <Fabricating Step> will be omitted for avoiding the repeated description, and <Content of Calculation/Measurement and Result thereof> and <Evaluation> will be mainly described below.

Also in Comparative Example 7, as in Comparative Example 6, the obtained electrode itself and the secondary battery including the electrode were evaluated for (1) the porosity for each of the regions of the electrode material layer and the area ratio of the void part (%), (2) the discharge rate retention ratio+the discharge cycle retention ratio (%), and (3) the electrolytic solution impregnability in the electrode under the same conditions and by the same method as described in Example 1. The results thereof are shown in Table 2 and Table 3.

As shown in Table 2, the magnitude relationship between the porosity for each region of the electrode material layer of the electrode (negative electrode) and the area ratio (%) of the void part was reverse to that in Example 1. Specifically, in Example 1, the porosities of the first region, second region, the third region were higher in this order. In contrast, the porosities of the first region, second region, and third region have been found to be lower in this order in Comparative Example 7. Under this condition, as shown in Table 2, the discharge rate retention ratio and the discharge cycle retention ratio (%) have been found below 70% of a predetermined standard as compared with Examples 1 to 3, and around about 60%. Furthermore, under such conditions, as shown in Table 3, the permeation time of the electrolytic solution in the electrode was about 1.4 times to about 1.7 times as long as that in Examples 1 to 3. From the foregoing, the electrolytic solution impregnability has been found to be poor as compared with those in Examples 1 to 3.

TABLE 2

| | | | | | | | | | | | Evaluation | |
|---|---|---|---|---|---|---|---|---|---|---|---|---|
| | | Electrode Material Layer Slurry | | | Porosity for Each | | | | | | Result of | |
| | Conditions | Upper | Lower | | Region of | | | Area Ratio of | | | Battery | |
| | for | Layer | Layer | | Electrode | | | Void Part in | | | Characteristics | |
| | Application | (Second | (First | | Material layer | | | Binarization | | | Discharge | Discharge |
| | (Upper | Electrode | Electrode | | (Calculated | | | Image J Electrode | | | Rate | Cycle |
| | Layer/ | Material | Material | | Value) | | | Section Analysis | | | Retention | Retention |
| | Lower | Layer | Layer | | Third | Second | First | Third | Second | First | Ratio | Ratio |
| | Layer) | Slurry) | Slurry) | Stripe | Region | Region | Region | Region | Region | Region | ( % ) | ( %) |
| Example 1 | continuous/ | containing | containing | yes | 38.2 | 35.0 | 30.0 | 3.3 | 3.0 | 2.0 | 78.0 | 85.2 |
| | intermittent | gactive | gactive | | | | | | | | | |
| | | material | material | | | | | | | | | |
| | | unlikely | likely | | | | | | | | | |
| | | to be | to be | | | | | | | | | |
| | | crushed | crushed | | | | | | | | | |
| Example 2 | continuous/ | containing | containing | yes | 39.6 | 35.5 | 27.7 | — | — | — | 73.2 | 78.2 |
| | intermittent | binder | binder | | | | | | | | | |
| | | in low | in high | | | | | | | | | |
| | | content | content | | | | | | | | | |
| | | proportion | proportion | | | | | | | | | |
| Example 3 | continuous/ | containing | containing | yes | 39.6 | 36.4 | 28.2 | — | — | — | 71.9 | 77.7 |
| | intermittent | conductive | conductive | | | | | | | | | |
| | | auxiliary | auxiliary | | | | | | | | | |
| | | agent in | agent in | | | | | | | | | |
| | | low | high | | | | | | | | | |
| | | content | content | | | | | | | | | |
| | | proportion | proportion | | | | | | | | | |
| Comparative | single | containing active | | no | — | 32.3 | | — | 2.3 | | 56.6 | 65.2 |
| Example 1 | continuous | material likely to | | | | | | | | | | |
| | | be crushed | | | | | | — | | | | |
| Comparative | single | containing active | | no | — | 35.0 | | — | 3.1 | | 60.3 | 63.3 |
| Example 2 | continuous | material unlikely | | | | | | | | | | |
| | | to be crushed | | | | | | | | | | |
| Comparative | continuous/ | containing | containing | no | — | 35.8 | 26.7 | — | 3.0 | 2.8 | 68.8 | 69.0 |
| Example 3 | continuous | active | active | | | | | | | | | |
| | | material | material | | | | | | | | | |
| | | unlikely | likely | | | | | | | | | |
| | | to be | to be | | | | | | | | | |
| | | crushed | crushed | | | | | | | | | |
| Comparative | continuous/ | containing | containing | no | — | 39.2 | 27.3 | — | — | — | 63.6 | 62.5 |
| Example 4 | continuous | binder | binder | | | | | | | | | |
| | | in low | in high | | | | | | | | | |
| | | content | content | | | | | | | | | |
| | | proportion | proportion | | | | | | | | | |
| Comparative | continuous/ | containing | containing | no | — | 42.0 | 28.0 | — | — | — | 60.1 | 59.6 |
| Example 5 | continuous | conductive | conductive | | | | | | | | | |
| | | auxiliary | auxiliary | | | | | | | | | |
| | | agent in | agent in | | | | | | | | | |
| | | low | high | | | | | | | | | |
| | | content | content | | | | | | | | | |
| | | proportion | proportion | | | | | | | | | |
| Comparative | continuous/ | containing | [symbol] ntaining | yes | 25.0 | 40.1 | 43.7 | 2.0 | 3.3 | 3.5 | 53.8 | 60.5 |
| Example 6 | intermittent | active | active | | | | | | | | | |
| | | material | [symbol] aterial | | | | | | | | | |
| | | likely | [symbol] likely | | | | | | | | | |
| | | to be | to | | | | | | | | | |
| | | crushed | [symbol] crushed | | | | | | | | | |
| Comparative | continuous/ | containing | containing | yes | 28.2 | 33.2 | 39.2 | — | — | — | 57.4 | 63.3 |
| Example 7 | intermittent | active | active | | | | | | | | | |
| | | material | material | | | | | | | | | |
| | | likely | unlikely | | | | | | | | | |
| | | to be | to be | | | | | | | | | |
| | | crushed | crushed | | | | | | | | | |

[symbol]

indicates data missing or illegible when filed

TABLE 3

| | Electrolytic Solution |
|---|---|
| | Impregnation Time |
| | (s) |
| Example 1 | 40 |
| Example 2 | 45 |
| Example 3 | 48 |
| Comparative | 78 |
| Example 1 | |
| Comparative | 72 |
| Example 2 | |
| Comparative | 80 |
| Example 3 | |
| Comparative | 68 |
| Example 4 | |
| Comparative | 68 |
| Example 5 | |
| Comparative | 55 |
| Example 6 | |
| Comparative | 66 |
| Example 7 | |

### INDUSTRIAL APPLICABILITY

The secondary battery according to an embodiment of can be used in various fields where power storage is assumed. By way of example only, the secondary battery, in particular, nonaqueous secondary battery according to an embodiment can be used in electric, information, and communication fields (for example, the fields of mobile devices such as cellular phones, smartphones, lap-top computers, digital cameras, activity meters, arm computers, and electronic papers) in which a mobile device or the like is used, home and small-size industrial applications (for example, the fields of electric tools, golf carts, domestic and nursing care, and industrial robots), large-size industrial applications (for example, the fields of forklifts, elevators, harbor cranes), transportation system fields (for example, fields such as hybrid vehicles, electric vehicles, buses, trains, power-assisted bicycles, and electric motorcycles), electric power system applications (for example, fields such as various types of electric power generation, load conditioners, smart grids, general household installation-type power storage systems), medical applications (fields of medical device such as earphone hearing aids), pharmaceutical applications (fields such as dosage management systems), IoT fields, space and deep-sea applications (for example, fields such as spacecraft and submersible research vehicles), and the like.

### DESCRIPTION OF REFERENCE SYMBOLS

10, 10I: Electrode
10A, 10AI: Positive electrode
10B, 10BI: Negative electrode
11, 11I: Current collector
11A, 11AI: Positive electrode current collector
11B, 11BI: Negative electrode current collector
12, 12I: Electrode material layer
12X, 12XI: First region
12XIa: Side part of first region
12X′: First electrode material layer slurry
12Y, 12YI, 12YI1, 12YI2, 12YI3: Second region
12YIa: Side part of second region
12Y′: Second electrode material layer slurry
12Z, 12ZI, 12ZI1, 12ZI2, 12ZI3: Third region
12Z′: Third electrode material layer slurry formed by entering uncoated part
12A, 12AI: Positive electrode material layer
12B, 12BI: Negative electrode material layer
12a: First main surface of electrode material layer
12b: Second main surface of electrode material layer
12α: Inner region of electrode material layer
12β: End region of electrode material layer
20, 20I: Electrolytic solution
30, 30I: Exterior body
50, 50I: Separator
60: Uncoated part
100, 100I: Electrode assembly
500, 500I: Secondary battery

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery electrode comprising:
a current collector; and
an electrode material layer provided on the current collector,
wherein the electrode material layer includes a first region, a second region, and a third region,
the first region and the third region are provided on the current collector,
the second region is provided at least on the first region, and
the first region, the second region, and the third region are higher in porosity in this order.

2. The secondary battery electrode according to claim 1, wherein the first region and the third region are adjacent to each other.

3. The secondary battery electrode according to claim 1, wherein the third region is located on two or more side parts of the first region located at a predetermined position.

4. The secondary battery electrode according to claim 1, wherein two or more third regions are provided at a predetermined interval on the current collector.

5. The secondary battery electrode according to claim 1, wherein
two or more first regions are provided at a predetermined interval on the current collector, and
the third region is provided so as to fill each space between one of the first regions adjacent to each other and the other first region.

6. The secondary battery electrode according to claim 1, wherein the electrode material layer includes a first main surface directly facing the current collector and a second main surface opposite to the first main surface, and the third region is provided such that the second main surface of the electrode material layer and the first region are connected to each other via the third region in a sectional view of the electrode.

7. The secondary battery electrode according to claim 6, wherein the electrode material layer includes the first main surface directly facing the current collector and the second main surface opposite to the first main surface, and the second region and the third region of the electrode material layer form a part of the second main surface of the electrode material layer in a plan view of the electrode.

8. The secondary battery electrode according to claim 6, wherein in a sectional view of the electrode, the third region is provided on the current collector so as to extend from the first main surface of the electrode material layer, the first main surface directly facing the current collector, to the second main surface opposite to the first main surface.

9. The secondary battery electrode according to claim 6, wherein the first region and the second region of the electrode material layer constitute a stacked body, and the third region extends so as to be in contact with the stacked body in a sectional view of the electrode.

10. The secondary battery electrode according to claim 9, wherein two or more stacked bodies are provided at a predetermined interval, and each of the third regions is provided so as to fill a space between one of the stacked bodies adjacent to each other and the other stacked body.

11. The secondary battery electrode according to claim 10, wherein the third region is provided in a stripe shape in a plan view of the electrode.

12. The secondary battery electrode according to claim 1, wherein when the electrode material layer includes more than three regions, the first region has a lowest porosity, whereas the third region has a highest porosity.

13. The secondary battery electrode according to claim 1, wherein the secondary battery electrode is capable of occluding and releasing lithium ions.

14. A secondary battery comprising the electrode according to claim 1.

15. A method for manufacturing a secondary battery electrode, the method comprising:
preparing a current collector;
providing an electrode material layer slurry on the current collector to form an electrode precursor; and
drying and pressing the electrode precursor,
wherein providing the electrode material layer slurry on the current collector to form the electrode precursor includes: intermittently applying at least two parts of a first electrode material layer slurry at a predetermined interval; and continuously applying, on the at least two parts of the first electrode material layer slurry, a second electrode material layer slurry that is relatively lower in volume ratio of a solid content containing an active material than the first electrode material layer slurry.

16. The manufacturing method according to claim 15, wherein in the continuous application, a part of the second electrode material layer slurry enters an uncoated part between parts of the first electrode material layer slurry.

17. The manufacturing method according to claim 16, wherein a volume ratio of a solid content including an active material in the electrode material layer slurry located in the uncoated part is made relatively lower than a volume ratio of a solid content including an active material in the second electrode material layer slurry on the first electrode material layer slurry.
